(19) United States
(12) Patent Application Publication
(10) Pub. No.: US 2014/0016295 A1
(43) Pub. Date: Jan. 16, 2014

(54) PROJECTION DEVICE

(71) Applicants: Min-Chen Huang, Hsin-Chu (TW); Cheng-Tien Chen, Hsin-chu (TW)

(72) Inventors: Min-Chen Huang, Hsin-Chu (TW); Cheng-Tien Chen, Hsin-chu (TW)

(21) Appl. No.: 13/547,021

(22) Filed: Jul. 11, 2012

(51) Int. Cl. H02B 1/20

(52) U.S. Cl. 361/827

(57) ABSTRACT

The projection device contains a main member, a transmission element, and an anti-slippery element. The main member has a built-in power element, an internal projection module, and an accommodation groove along a side of the main member for storing the transmission element. The anti-slippery element is configured on a major side of the main member for positioning a mobile device. An end of the transmission element is data-linked to the projection module, and the other end is configured with a MEL (mobile high-definition link) connector and is connected to the mobile device. The content on the screen of the mobile device is synchronously delivered to and projected by the projection module. The electricity required for the operation of the projection device is provided from the power element. The power element can also be used to charge the mobile device when no projection from the latter is required.

### TECHNICAL FIELD OF THE INVENTION

The present invention is generally related to projection devices, and more particularly to a projection device for projecting a mobile device's content.

### DESCRIPTION OF THE PRIOR ART

To playing a video or content on a display device, a smart phone (such as an android phone) usually requires a MHL (mobile high-definition link) device for the delivery of video or content to the display device. Currently, an MHL device often requires an external power source for its operation. However, the power source sometimes is not easy to locate.

R.O.C. Taiwan Patent No. M429258 teaches a MHL device having an adaptor module, a detector module, a power module, and a battery. The power module can be switched to use either an external power source or the battery. The adaption module delivers the signal from a smart phone or a tablet to a display device. The detector module can detect the presence of signal and turns on the adaption module automatically. The detector module can also automatically switch between the external power source and the battery, or turn off the MHL device for power saving. In other words, the MHL device with the built-in battery does not require an external power source for its operation.

In addition, R.O.C. Taiwan Patent No. M424513 teaches a projection device having a base seat and a side seat. An end of the base seat is joined to an edge of the side seat so as to jointly support a portable communication device such as iPhone. A side of the side seat adjacent to the base is configured with a connector for connection to a first connection hole. Another side of the side seat that is away from the base seat is configured with a switch and a second connection hole. The connector and the second connection hole are electrically connected together. The switch is electrically connected with the second connection hole. An end of the base seat that is away from the side seat has a micro projection module configured in a corner. Another corner is configured with a notch so as not to block a camera of the portable communication device.

The foregoing prior arts have the following disadvantages.

Firstly, the MHL device taught by the R.O.C. Taiwan Patent No. M429258 does not have a built-in display module. A user has to carry or locate one for viewing the video or content.

Secondly, the interface provided by the R.O.C. Taiwan Patent No. M424513 is not a high-definition one. Furthermore, the connector is configured directly on the side seat. Therefore, after a period of usage, it could be damaged. The portable communication device has to be neatly aligned so as to connect with the connector. Some misalignment could cause damage to the connector.

### SUMMARY OF THE INVENTION

A major objective of the present invention is that, to project high-definition content, the MHL (mobile high-definition link) connection is adopted.

Another objective of the present invention is that, to project a mobile device's content, the mobile device can be reliably placed on the projection device.

Yet another objective of the present invention is that, to achieve convenient carriage, an accommodation groove is configured for storing a transmission element.

Still another objective of the present invention is that, to also function as a mobile power source to charge the mobile device, the projection device has a built-in power element.

To achieve the objectives, a projection device of the present invention contains a main member, a transmission element, and an anti-slippery element. The main member has a built-in power element, an internal projection module electrically connected with the power element, and an accommodation groove along a side of the main member for storing the transmission element. The anti-slippery element is configured on a major side of the main member for positioning a mobile device. An end of the transmission element is data-linked to the projection module and the other end is configured with a MHL (mobile high-definition link) connector. The mobile device is first attached to the anti-slipper element. Then, the transmission element is pulled out of the accommodation groove and its MHL connector is connected to the mobile device. The projection device is then powered on and the content on the screen of the mobile device is then synchronously delivered to and projected by the projection module onto a white background. The electricity required for the operation of the projection device is provided from the power element. The power element can also be used to charge the mobile device when no projection from the latter is required. The projection device therefore has the advantage of versatility.

The present invention obviates the shortcomings of conventional mobile devices that, when there is a need for projection, a projection device has to be located or carried, or the projection device does not support the MHL interface and as such suffers poor image quality or lack of synchronous projection, or the connector can be easily damaged during carriage.

The foregoing objectives and summary provide only a brief introduction to the present invention. To fully appreciate these and other objects of the present invention as well as the invention itself, all of which will become apparent to those skilled in the art, the following detailed description of the invention and the claims should be read in conjunction with the accompanying drawings. Throughout the specification and drawings identical reference numerals refer to identical or similar parts.

Many other advantages and features of the present invention will become manifest to those versed in the art upon making reference to the detailed description and the accompanying sheets of drawings in which a preferred structural embodiment incorporating the principles of the present invention is shown by way of illustrative example.

### BRIEF DESCRIPTION OF THE DRAWINGS

FIG. 1 is a perspective diagram showing a projection device according to an embodiment of the present invention.

FIG. 2 is another perspective diagram showing the projection device of FIG. 1.

FIG. 3 is a block diagram showing the major functional blocks of the projection device according to the present invention.

FIG. 4 is a perspective diagram showing a mobile device being placed on the projection device of FIG. 1.

FIG. 5 is a perspective diagram showing FIG. 4's projection device and mobile device being connected together.

FIG. 6 is a perspective diagram showing FIG. 5's projection device with its retractable stand extended.

FIG. 7 is a perspective diagram showing FIG. 6's projection device projecting the content from the mobile device.

FIG. 8 is a perspective diagram showing a projection device according to an embodiment of the present invention.

### DETAILED DESCRIPTION OF THE PREFERRED EMBODIMENTS

The following descriptions are exemplary embodiments only, and are not intended to limit the scope, applicability or configuration of the invention in any way. Rather, the following description provides a convenient illustration for implementing exemplary embodiments of the invention. Various changes to the described embodiments may be made in the function and arrangement of the elements described without departing from the scope of the invention as set forth in the appended claims.

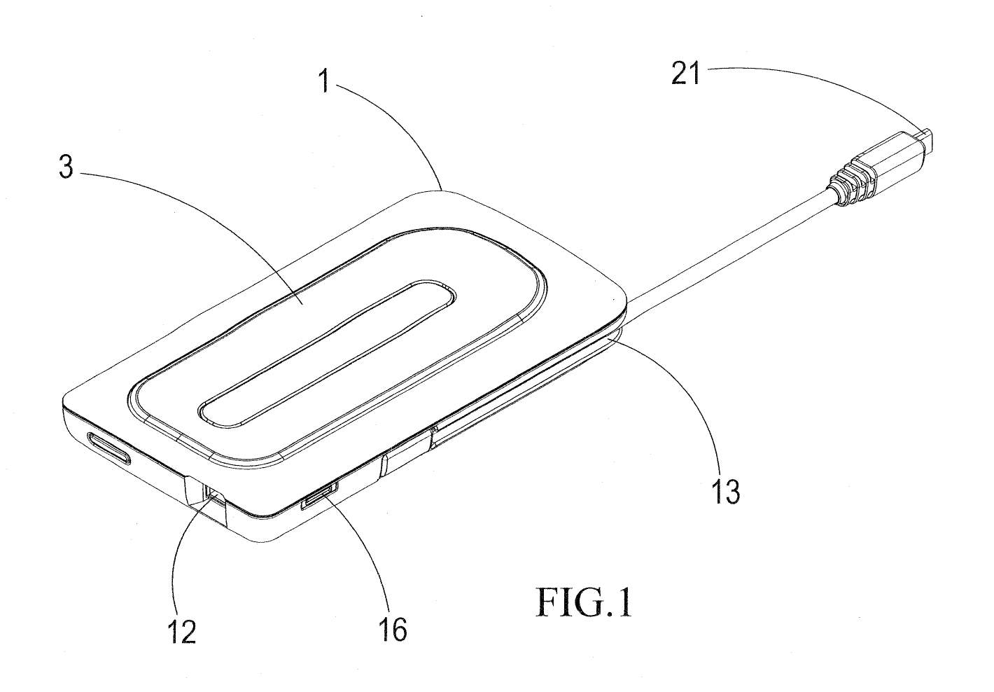

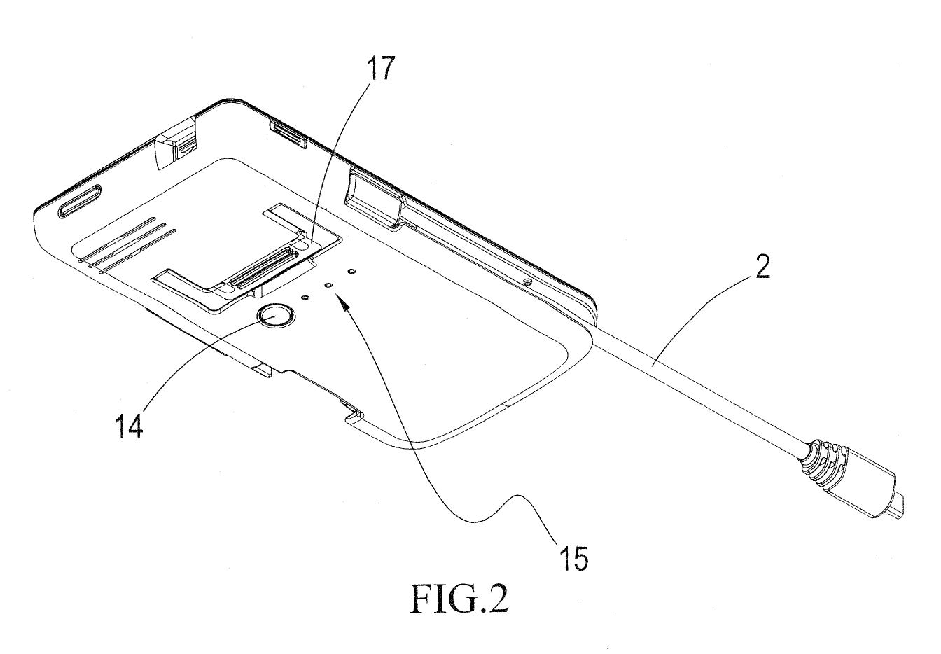

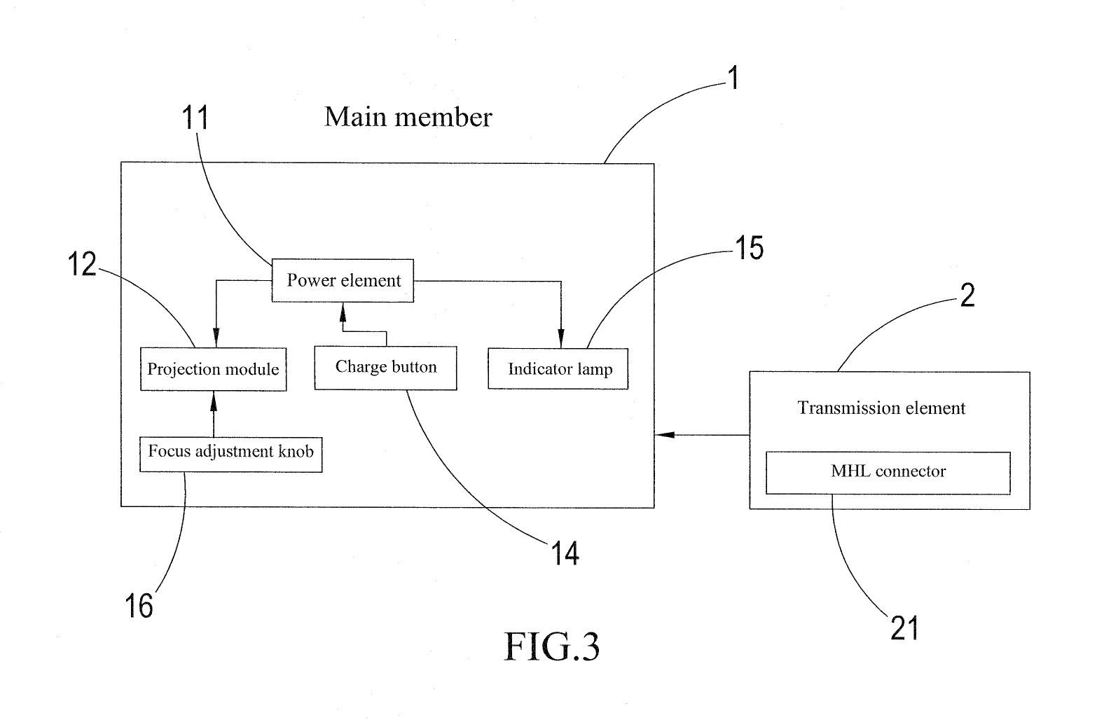

As shown in FIGS. 1 to 3, a projection device according to an embodiment of the present invention contains a main member 1, a transmission element 2, and an anti-slippery element 3.

The main member 1 has a built-in power element 11, such as a battery or a super capacitor, an internal projection module 12 electrically connected with the power element 11, and an accommodation groove 13 along a side of the main member 1. On a major side of the main member 1, there are a charge button 14, at least an indicator lamp 15, a focus adjustment knob 16, and a retractable stand 17. The charge button 14 and the indicator lamp 15 are electrically connected with the power element 11. The focus adjustment knob 16 is electrically connected with the projection module 12.

The transmission element 2 is connected to the main member 1 and can be stored in the accommodation groove 13. Preferably, the transmission element 2 is a MHL (mobile high-definition link) cable. An end of the transmission element 2 is data-linked to the projection module 12 and the other end is configured preferably with a MHL connector 21.

The anti-slippery element 3 is made of silicone and is configured on another major side of the main member 1.

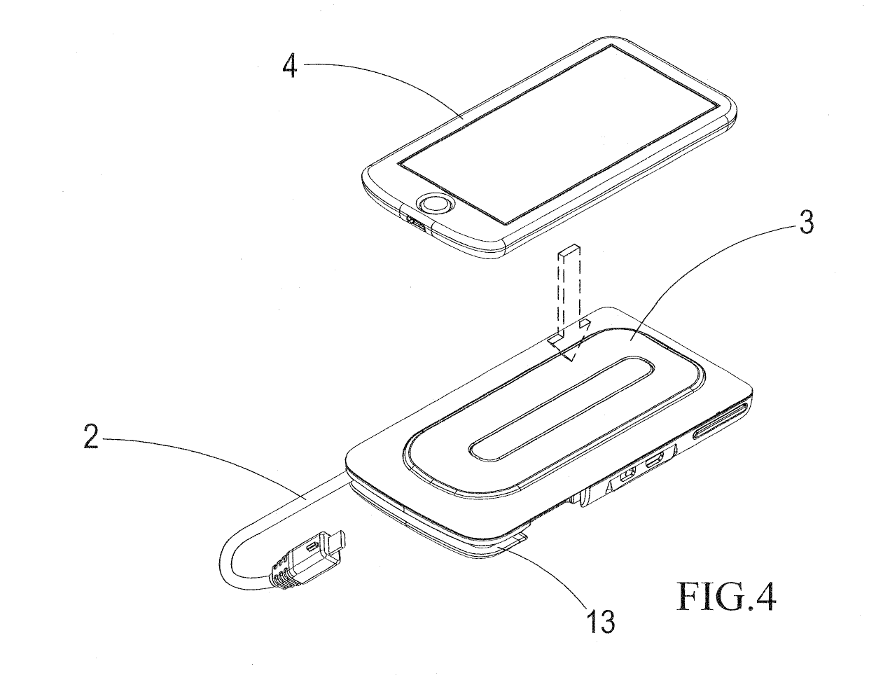

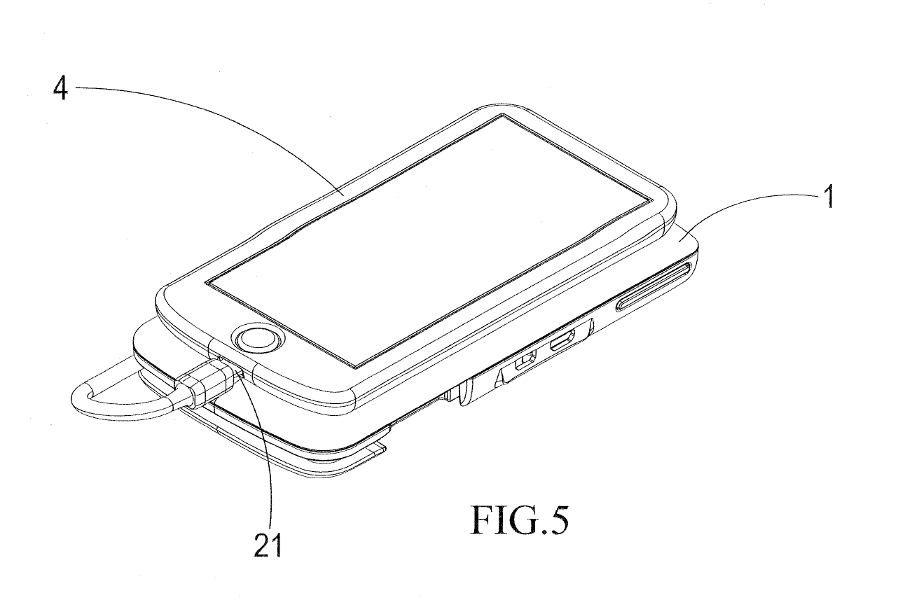

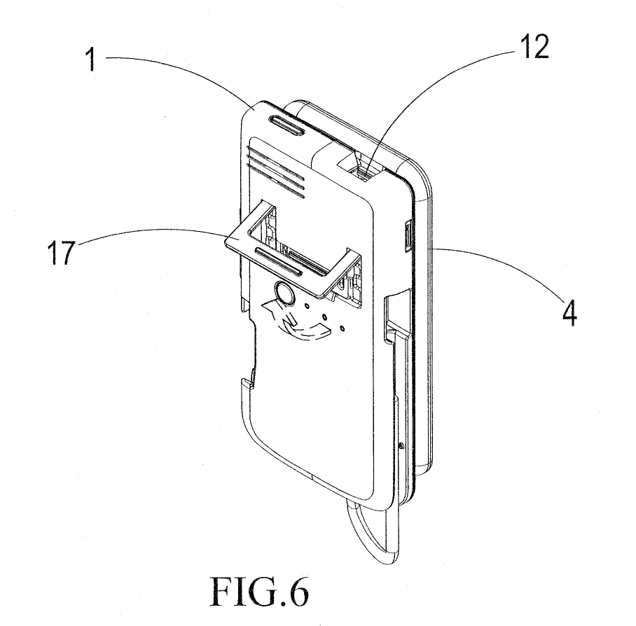

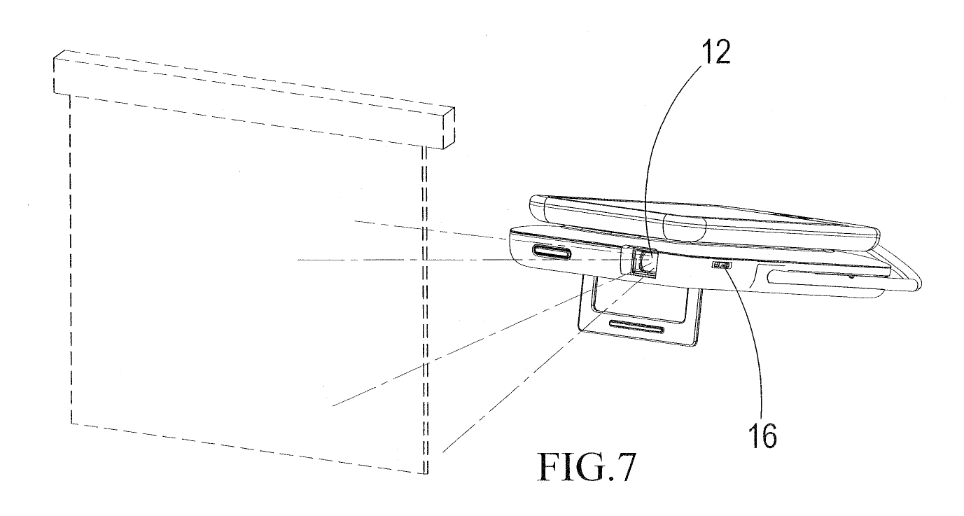

The projection device is utilized as follows. As shown in FIGS. 4 to 7, to use the projection device to project content from a mobile device 4 (e.g., a smart phone), the mobile device 4 is first attached to the anti-slipper element 3. Then, the transmission element 2 is pulled out of the accommodation groove 13 and its MEL connector 21 is connected to the mobile device 4. The projection device is then powered on and the power element 11 starts to provide electricity to the projection module 12. The content on the screen of the mobile device 4 is then synchronously delivered to and projected by the projection module 12 through the transmission element 2. The clarity of the projection can be adjusted by the focus adjustment knob 16. The retractable stand 17 can be set up to raise the main member 1 so that the projection is projected to an appropriate position.

The projection device can also be used to charge the mobile device 4 as follows. The mobile device 4 is first attached to the anti-slipper element 3. Then, the transmission element 2 is pulled out of the accommodation groove 13 and its MHL connector 21 is connected to the mobile device 4. Then, by activating the charge button 14, the power element 11 starts to provide electricity to charge the mobile device 4 through the transmission element 2. The amount of electricity remained in the power element 11 can be determined by observing the indicator lamp 15.

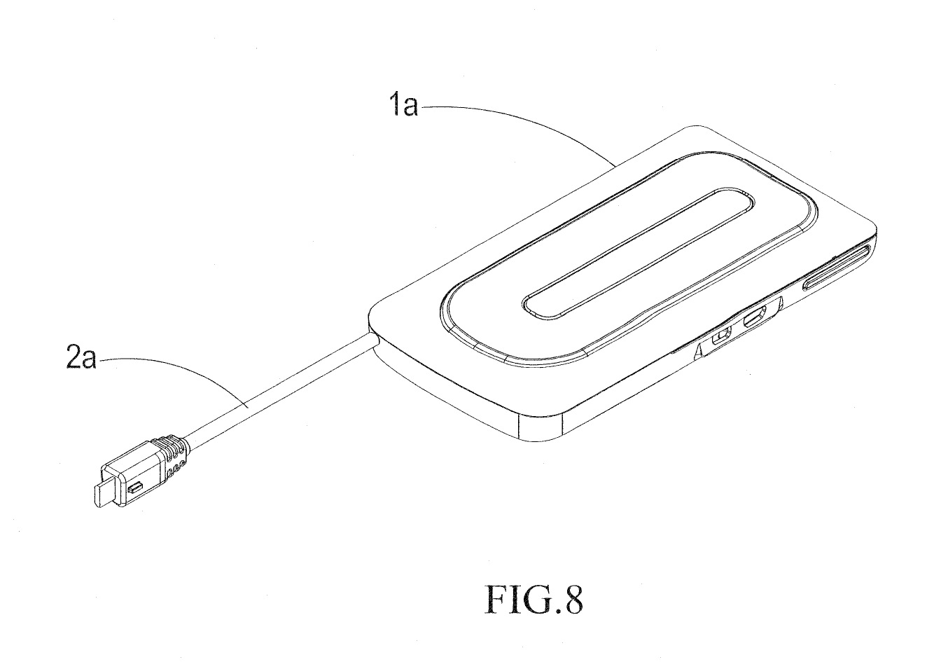

A projection device according to another embodiment of the present invention is shown is shown in FIG. 8. The difference between the present embodiment and the previous one is that there is no accommodation groove configured on the main member 1a, and the transmission element 2a is directly exposed. When the projection device is put to use, a user simply connects the transmission element 2a to a mobile device.

Compared to prior arts, the present invention has the following advantages.

Firstly, a superior of applicability is achieved by the projection of high-definition content through the employment of the MEL cable and connector.

Secondly, the mobile device can be reliably placed on the anti-slippery element.

Thirdly, the transmission element can be stored in the accommodation groove for convenient carriage.

Fourthly, the power element can be used to provide stored electricity to the mobile device, in addition to the projection device itself.

While certain novel features of this invention have been shown and described and are pointed out in the annexed claim, it is not intended to be limited to the de ails above, since it will be understood that various omissions, modifications, substitutions and changes in the forms and details of the device illustrated and in its operation can be made by those skilled in the art without departing in any way from the spirit of the present invention.

I claim:

1. A projection device, comprising:
a main member having a built-in power element, and an internal projection module electrically connected with the power element;
a transmission element having one end data-liked to the projection module and the other end configured with a MHL (mobile high-definition link) connector; and
an anti-slippery element on a major side of the main member.

2. A projection device, comprising:
a main member having a built-in power element, an internal projection module electrically connected with the power element, and an accommodation groove along a side of the main member;
a transmission element having one end data-liked to the projection module and the other end configured with a MHL (mobile high-definition link) connector; and
an anti-slippery element on a major side of the main member.

3. The projection device according to claim 1, wherein the main member further comprises a charge button electrically connected with the power element.

4. The projection device according to claim 2, wherein the main member further comprises a charge button electrically connected with the power element.

5. The projection device according to claim 1, wherein the main member further comprises an indicator lamp electrically connected with the power element.

6. The projection device according to claim 2, wherein the main member further comprises an indicator lamp electrically connected with the power element.

7. The projection device according to claim 1, wherein the main member further comprises a retractable stand on another major side of the main member.

8. The projection device according to claim 2, wherein the main member further comprises a retractable stand on another major side of the main member.

9. The projection device according to claim 1, wherein the main member further comprises a focus adjustment knob.

10. The projection device according to claim 2, wherein the main member further comprises a focus adjustment knob.

11. The projection device according to claim 1, wherein the power element is one of a battery and a super capacitor.

12. The projection device according to claim 2, wherein the power element is one of a battery and a super capacitor.

13. The projection device according to claim 1, wherein the transmission element is a MHL cable.

14. The projection device according to claim 2, wherein the transmission element is a MHL cable.

15. The projection device according to claim 1, wherein the anti-slippery element is made of silicone.

16. The projection device according to claim 2, wherein the anti-slippery element is made of silicone.
